(19) United States
(12) Patent Application Publication
(10) Pub. No.: US 2026/0170581 A1
(43) Pub. Date: Jun. 18, 2026

(54) PROPERTY TRANSFER TRANSACTION FACILITATION

(71) Applicant: Speed Estate Inc., Downey, CA (US)

(72) Inventor: Ali Hijazi, Downey, CA (US)

(73) Assignee: Speed Estate Inc., Downey, CA (US)

(21) Appl. No.: 19/533,785

(22) Filed: Feb. 9, 2026

Related U.S. Application Data
(63) Continuation-in-part of application No. 18/886,825, filed on Sep. 16, 2024.

(51) Int. Cl. G06Q 50/16; G06Q 30/0601; H04L 51/046

(52) U.S. Cl. CPC G06Q 50/167; G06Q 30/0609; H04L 51/046

(57) ABSTRACT

End-to-end property transfer transactions can be facilitated. The facilitating can include managing listing user profiles such as listing owner user profiles and/or listing agent user profiles, digital property listings of the listing user profiles, acquiring user profiles, and service provider user profiles. The facilitating can also include, tracking and coordinating the property transfer transactions from listing of properties represented by the digital property listings to completion of transfers of properties represented by the digital property listings from listing users represented by the listing user profiles to acquiring users represented by acquiring user profiles. The tracking and coordinating can include providing digital property listings representing properties available for transfer; filtered messaging between the listing user profiles and the acquiring user profiles; maintaining and providing digital documents for the property transfer transactions; and maintaining and providing status updates for the property transfer transactions.

### RELATED APPLICATIONS

The present application is a continuation in part of U.S. application Ser. No. 18/886,825, filed Sep. 16, 2024, and titled PROPERTY TRANSFER TRANSACTION FACILITATION, which is incorporated herein by reference. If any disclosures are incorporated herein by reference and such incorporated disclosures conflict in part or whole with the present disclosure, then to the extent of conflict, and/or broader disclosure, and/or broader definition of terms, the present disclosure controls. If such incorporated disclosures conflict in part or whole with one another, then to the extent of conflict, the later-dated disclosure controls.

### BACKGROUND

Computers have been used in various ways in facilitating parts of property transfer transactions, such as transactions for the sale or lease of property, such as real estate. Such facilitation has been limited and has had shortcomings and drawbacks.

### SUMMARY

The disclosure relates to computer-implemented facilitation of property transfer transactions.

In one aspect, end-to-end property transfer transactions can be facilitated. The facilitating can include managing listing user profiles (which may include listing owner user profiles and/or listing agent user profiles), digital property listings of the listing user profiles, acquiring user profiles, and service provider user profiles. The facilitating can also include tracking and coordinating the property transfer transactions from listing of properties represented by the digital property listings to completion of transfers of properties represented by the digital property listings from listing users represented by the listing user profiles to acquiring users represented by acquiring user profiles. The tracking and coordinating can include providing digital property listings representing properties available for transfer; filtered messaging between the listing user profiles and the acquiring user profiles; maintaining and providing digital documents for the property transfer transactions; and maintaining and providing status updates for the property transfer transactions.

In another aspect, the tools and techniques can include receiving digital property listing data from listing user profiles (such as listing owner user profiles and/or listing agent user profiles); using the digital property listing data to provide digital property listings to acquiring user profiles; receiving user input from an acquiring user profile selecting a digital property listing; and determining that the acquiring user profile does not have a current prequalification value range in the computer system that includes a listing value of the digital property listing. The technique can also include, in response to determining that the acquiring user profile does not have a current prequalification value range in the computer system that includes the listing value of the digital property listing, performing the following: blocking the acquiring user profile from messaging a listing user profile for the digital property listing through a messaging user interface control in the digital property listing; and providing a user interface control that is selectable to forward the acquiring user profile to a prequalification service. Additionally, the technique can include receiving from the prequalification service an indication of a new prequalification range for the acquiring user profile; and verifying that the new prequalification range includes the listing value of the digital property listing. Also, the technique can include, in response to verifying that the new prequalification range includes the listing value of the digital property listing, providing the acquiring user profile with a message user interface control associated with the digital property listing, the message user interface control being selectable to initiate sending a digital message from the acquiring user profile to the listing user profile. And the technique can include sending a message from the acquiring user profile to the listing user profile after selection of the message user interface control.

In another aspect of the tools and techniques, a technique can include facilitating, via a computer subsystem, end-to-end property transfer transactions. The facilitating can include managing listing user profiles, digital property listings of the listing user profiles, acquiring user profiles, and service provider user profiles. The facilitating can also include, at a single available computer subsystem, tracking and coordinating the property transfer transactions from listing of properties represented by the digital property listings to completion of transfers of properties represented by the digital property listings from listing users represented by the listing user profiles to acquiring users represented by acquiring user profiles. The tracking and coordinating can include providing digital property listings representing properties available for transfer; messaging between the listing user profiles and the acquiring user profiles, the messaging including limiting messages from acquiring user profiles to listing user profiles to only be from acquiring user profiles with digital indications of prequalification value ranges that include listing values of digital property listings of listing user profiles to whom the messages are to be sent, where the listing user profiles can include one or more listing agent user profiles that correspond to agents of owners of properties represented by one or more of the digital property listings and/or one or more listing owner user profiles that correspond to owners of properties represented by one or more of the digital property listings; maintaining and providing digital documents for the property transfer transactions; and maintaining and providing status updates for the property transfer transactions.

In yet another aspect of the tools and techniques, a technique can include facilitating, via a computer subsystem, end-to-end property transfer transactions. The facilitating can include managing listing user profiles, digital property listings of the listing user profiles (which can include listing owner user profiles and/or listing agent user profiles), acquiring user profiles, and service provider user profiles; and, at a single available computer subsystem, tracking and coordinating the property transfer transactions from listing of properties represented by the digital property listings to completion of transfers of the properties represented by the digital property listings from listing users represented by the listing user profiles to acquiring users represented by acquiring user profiles. The tracking and coordinating can include receiving user input from an acquiring user profile selecting a digital property listing; and in response to receiving the user input directed at the digital property listing, determining that the acquiring user profile does not have a current digital prequalification value range that includes a listing value of the digital property listing. The tracking and coordinating can also include, in response to determining that the acquiring user profile does not have a current digital prequalification value range that includes the listing value of the digital property listing, performing the following: blocking the acquiring user profile from messaging a listing user profile of the digital property listing through a messaging user interface control in the digital property listing; and providing in association with the digital property listing a user interface control that is selectable to forward the acquiring user profile to a prequalification service. The tracking and coordinating can further include receiving from the prequalification service an indication of a new prequalification range for the acquiring user profile; verifying that the new prequalification range includes the listing value of the digital property listing; in response to verifying that the new prequalification range includes the listing value of the digital property listing, providing the acquiring user profile with a message user interface control associated with the digital property listing, the message user interface control being selectable to initiate sending a digital message from the acquiring user profile to the listing user profile; and sending a message from the acquiring user profile to the listing user profile after selection of the message user interface control.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

FIG. 1 is a block diagram of a suitable computing environment in which one or more of the described aspects may be implemented.

FIG. 2 is a schematic diagram of a property transfer transaction facilitation system.

FIG. 3 is an illustration of an example of a property listing in a display on a client device.

FIG. 4 is an illustration of another example of a property listing in a display on a client device.

FIG. 5 is an illustration of an example of a message display.

FIG. 6 is a flowchart illustrating a property transfer transaction facilitation technique.

FIG. 7 is another flowchart illustrating a property transfer transaction technique.

FIG. 8 is yet another flowchart illustrating a property transfer transaction technique.

### DETAILED DESCRIPTION

Aspects described herein are directed to techniques and tools for improved facilitation of property transfer transactions. Such improvements may result from the use of various techniques and tools separately or in combination.

Such techniques and tools may include ideas for a specialized online real estate transaction computer subsystem, which can interact with user devices. For example, the subsystem may include a computer subsystem that can include server resources and possibly also client resources such as dedicated mobile apps on client devices. The subsystem can handle property listings and the real estate transaction process from listing to completion of the property sale.

In the subsystem, a seller may list a property by entering information for the seller's property. The system can get property information from government websites or other such sources, possibly through application programming interfaces, and it can be corrected and supplemented with information from the seller. The property can be listed on the subsystem website and available on the subsystem apps. It can also be pushed out to other third-party listing sites that include property listings, such as through application programming interfaces. In those listings on third-party sites, the subsystem can be linked for the agent or seller information, so that clicks from the other listing sites can be forwarded to the real estate transaction subsystem. In an example, sellers may agree that the subsystem operator gets a commission on the sale price of their property (e.g., a 1% commission), even if the seller ultimately ends up selling through some other avenue.

A buyer can browse listings on the subsystem. If the buyer wants to message a seller through the system, then the buyer can enter information and work with an associated third party (e.g., a lender) to be pre-approved for a certain amount of purchase price. After that, the buyer can message sellers of any properties on the subsystem having listing prices at or below the amount for which the buyer has been pre-approved. The service providers may provide portions of their received payments as compensation to the subsystem, and the subsystem can negotiate lower prices with them so that users can pay lower prices.

The subsystem can manage profiles for and/or otherwise interact with multiple different types of real estate service providers, including escrow companies, title companies, lenders, appraisers, and inspectors. Transaction managers such as escrow companies can manage the process, including providing the sales contract to be signed by the buyer and seller, holding escrow funds, and entering status information for the transaction process, including status information from the title companies, lenders, and other service providers.

In the system, a buyer can message a seller for a property within the buyer's prequalified value range and can make an offer to purchase it. The seller can respond by accepting it, denying it, or making a counteroffer. Once an offer or counteroffer is accepted, then the buyer and seller can indicate in the system that they want to engage a transaction manager such as an escrow agent company, a title agent or company, or other transaction manager to provide the sales contract. The transaction manager can then send a message to a transaction manager with data about the transaction, such as data from the buyer's profile, data from the seller's profile, data about the property listing, and possibly other data such as data about messages between the buyer and seller profiles. The transaction manager may then draft the sales contract, communicating with the buyer and seller as necessary, and provide the contract to the buyer and seller for signatures. The transaction manager may also send the signed contract to the transaction subsystem.

The sales process can continue from there with the transaction manager managing the process, and the transaction manager and the buyer and seller interacting with the other service providers. The transaction manager can be tasked with periodically updating the status of the transaction in the subsystem, and the parties (the buyer, seller, and possibly at least some service providers such as the transaction manager and/or a listing agent) can have access to the status information. Accordingly, this can reduce the headaches, waiting time, and messages/calls that need to be made to find out the current status of the multiple aspects of the real estate transaction process. Thus, it can increase speed and reduce use of computer resources and time spent by users in the transaction process.

As signatures are needed, they can be requested for digital signing. And if wet pen signatures and/or notary services are needed for some signatures, then mobile notary or signature collection services can be retained to go to people's homes or businesses to get the signatures.

Some features that may be present in the subsystem are discussed below. The subsystem may provide an end-to-end single-source solution for the real estate purchase and sale process. Users can get convenience and value from the subsystem, and they can trust the process and the contacts provided through the subsystem. The subsystem can manage the profiles for buyers, sellers, and service providers. The subsystem can track and coordinate a real estate sales transaction process from listing of the property to the completion of the sale. This can provide for increased efficiency in the computer system by reducing redundancy in terms of computer operations, storage, and network bandwidth usage, in addition to increasing efficiency of users' time.

The subsystem can include messaging tools. The messaging can be provided through the subsystem, where a buyer gets pre-approved for a sale amount by a lender and can only message sellers with listings at or below the value amount of the pre-approval. So, for example, if a buyer is prequalified to purchase a house at $900,000, then that buyer can message sellers with properties listed at $900,000 and below (so the prequalified value range would be from $0 to $900,000). This can reduce the load on the computer system, and it can reduce wasted time from sellers responding to potential buyers who are not adequately qualified.

The subsystem can push out listings to third party listing sites through application programming interfaces. This pushing out of the listings to third party listing sites may be done via one or more listing publisher user profiles. If a buyer clicks on a listing from a third-party listing site, the link can take the buyer to the corresponding listing on the subsystem website or app, where the buyer can review the listing and can get pre-approved for the necessary amount to allow messaging of the seller for the listing. This arrangement can improve efficiency of the listing process and the process of buyers using computer systems to review digital listings and digitally message sellers of the listings.

Status updates for property transfer transactions can be provided through the single source subsystem, where the buyer, the seller, and the service providers can have access to the status updates provided in the system. This can reduce the amount of messaging, phone calls, waiting and hassles for the various parties in trying to determine the current status of the different aspects of the transaction (such as the status of the loan, the status of the appraisal, the status of the inspection, etc.). Accordingly, it can provide a more efficient computer system for facilitating property transfer transactions.

The system can also facilitate interactions with sellers' agents and/or with publishers such as real estate brokers who can be responsible for publishing a listing with various listing publishing services, such as the MLS system and/or other third-party property listing publishing services, such as the third-party property listing publishing service operating under the trademark Zillow®. For example, there may be a publisher such as a broker for each of multiple jurisdictions, such as in each state in the United States of America where listed properties are located. Accordingly, this publishing feature can involve state-specific licensed real estate brokers pushing the property listings into the MLS system and other listing sources such as those operating under trademarks Zillow®, Homes.com®, Redfin®, etc. The publisher can take actions to publish and be responsible for publishing listings from the transaction service on MLS and other third-party listing services. The listings can also be published directly by the transaction service discussed herein. The publisher may be an individual who is a licensed broker, and the publisher may have a position in a company that runs the transaction service discussed here, such as where the publisher is an officer associated with the company. This publisher can use the transaction service to execute the publication of the listings from the transaction service on third-party listing publisher services. For example, the transaction service may receive user input from the publisher (such as through a listing publisher user profile associated with the publisher) and respond by sending data from the property listings in the transaction service (such as through API calls) to third-party listing publisher services, which can respond by publishing the listings on their own service systems. Those published listings on the third-party services (which are computer services in the overall computer system discussed herein) can include links back to the transaction service, so that when a buyer visiting a website or app provided by one of the third party services selects a link on a published listing on that website or app, the buyer's user profile can be connected to the transaction service, thereby invoking the features of the transaction service discussed herein. Such use of the transaction service to publish the listings on third-party listing publishing services can decrease the computing resources and the amount of time and hassle required by users required to publish the listings on such services, as compared to a user manually publishing the listings individually on the transaction service and on such third-party services.

A seller may come directly to the system. In other situations, a seller's agent or broker can bring their client's (the seller's) listing to the transaction service. In this case, the seller's agent can interact via the transaction service on behalf of the seller, such as by messaging with a buyer through the transaction service and/or performing other actions discussed herein as being performed by a listing user profile. But in this situation with a seller's agent, there can be a profile for the seller's agent, and a profile for the seller. The actions discussed herein as being done by the listing user profile may be done by the seller's agent's user profile, although some actions may still be done by the seller's user profile (such as signing documents via the seller's user profile or accessing status data for the transaction). Moreover, the seller's user profile can interact with the seller's agent's user profile, such as messaging between the seller's user profile and the seller's agent's user profile. Also, the system can allow each of them to see appropriate status information provided via the transaction service, and also the system can message each of them and request input in appropriate situations. A single seller's agent may bring many of their sellers to the site, so the seller's agent would use the same profile for different transactions with different sellers and different property listings. Besides having these two profiles, the system could operate the same way as in a situation that does not include a separate seller's agent profile. For example, the system's interactions with the seller's profile can be with one or the other of these two seller-related profiles (the profile of the seller or the profile of the seller's agent), or with both of them.

In the situation where the seller is represented by a seller's agent (entry where a seller's agent or broker brings their client's (the seller's) listing to the transaction service), the system can still verify the property owner using information entered by the seller's agent (via the seller's agent's user profile) and/or by the seller itself (via the seller's user profile). The system can also verify that the seller's agent is actually the agent for the owner of the property represented by the property listing, such as by requesting and receiving confirmation (such as via a message in the system and/or user input received on a webpage or app page provided by the system) from the seller's user profile after the seller's user profile has been verified as representing the owner of the property represented by the property listing.

Also, in some circumstances, a buyer and seller may come to a general agreement on the transfer of a property before interacting with the system regarding the property (buyer/seller accepted entry point). In such a situation, a property listing for the property may not be published using the transaction service. Rather, the seller can enter the seller's information and sufficient information for making an agreement with the buyer (such as real estate purchase contract information, including the buyer's contact information). The system can still verify the owner of the property via the transaction service, as discussed herein. And the system can then send a message to the buyer via the transaction service, asking the buyer to sign the agreement. If the buyer already has a profile, this can be done through the transaction service (it can use identifying information about the buyer from what the seller entered to make sure it contacts the correct buyer). If the buyer does not have a profile yet, then the system can contact the buyer using the contact information entered by the seller (such as by sending a digital message), and the system can provide the buyer with a link in the message, inviting the buyer to create a user profile in the transaction service. After the user profile is created, the buyer can use the system to enter the buyer's signature on the agreement. The seller can also use the system to enter the seller's signature on the agreement before, after, or in parallel with the system being used to enter the buyer's signature on the agreement. After that is done, the transaction can proceed using the system like other transactions described herein. Thus, the system can automatically mandate that both the buyer and the seller create a respective user profile. Also, the system can require both the buyer and seller to complete an offer acceptance form to initiate escrow opening. For at least some verifications such as for authenticating documents such as property documents and/or identifying a seller's agent, a seller, a buyer, and/or other parties, the system can utilize a remote notarization service for KYC (Know Your Customer) to verify identification and/or authenticate documents.

The discussion above discusses interactions with buyers and sellers. However, the subsystem may be used without any exchange of money and with different types of property transfers (e.g., gifts, outright sales, leases, etc.). Thus, instead of referring to a buyer or a buyer user profile, discussions herein may refer to an acquiring user or an acquiring user profile. Similarly, instead of referring to a seller or a seller user profile, discussions herein may refer to a listing user (which may be a listing owner and/or a listing owner's agent) or a listing user profile (which may be a listing owner user profile and/or a listing agent user profile). Also, the subsystem can actually store, operate, and interact with user profiles of the users that are buyers, sellers, administrative users, third party service providers, etc. As used herein, a user profile is a set of data that represents an entity such as a user, a group of users, a company, a computing resource, etc. When references are made herein to a user profile performing actions (sending, receiving, etc.), those actions are considered to be performed by a user profile if they are performed by computer components in an environment where the user profile is active (such as where the user profile is logged into an environment and that environment controls the performance of the actions). Often such actions by or for a user profile are also performed by or for a user corresponding to the user profile. For example, this may be the case where a user profile is logged in and active in a computer application and/or a computing device that is performing actions for the user profile on behalf of a corresponding user. To provide some specific examples, this usage of terminology related to user profiles applies with references to a user profile providing user input, receiving responses, or otherwise interacting with computer components discussed herein.

The subject matter defined in the appended claims is not necessarily limited to the benefits described herein. A particular implementation of the invention may provide all, some, or none of the benefits described herein. Although operations for the various techniques are described herein in a particular, sequential order for the sake of presentation, it should be understood that this manner of description encompasses rearrangements in the order of operations, unless a particular ordering is required. For example, operations described sequentially may in some cases be rearranged or performed concurrently. Moreover, for the sake of simplicity, flowcharts may not show the various ways in which particular techniques can be used in conjunction with other techniques.

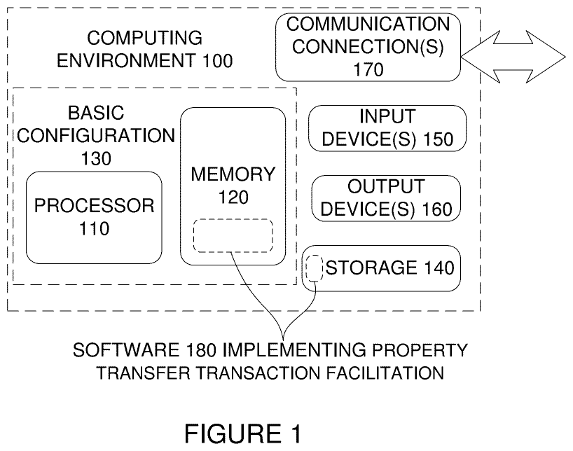

Techniques described herein may be used with one or more of the systems described herein and/or with one or more other systems. For example, the various procedures described herein may be implemented with hardware or software, or a combination of both. For example, the processor, memory, storage, output device(s), input device(s), and/or communication connections discussed below with reference to FIG. 1 can each be at least a portion of one or more hardware components. Dedicated hardware logic components can be constructed to implement at least a portion of one or more of the techniques described herein. For example, and without limitation, such hardware logic components may include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc. Applications that may include the apparatus and systems of various aspects can broadly include a variety of electronic and computer systems. Techniques may be implemented using two or more specific interconnected hardware modules or devices with related control and data signals that can be communicated between and through the modules, or as portions of an application-specific integrated circuit. Additionally, the techniques described herein may be implemented by software programs executable by a computer system. As an example, implementations can include distributed processing, component/object distributed processing, and parallel processing. Moreover, virtual computer system processing can be constructed to implement one or more of the techniques or functionalities, as described herein.

### I. Exemplary Computing Environment

FIG. 1 illustrates a generalized example of a suitable computing environment 100 in which one or more of the described aspects may be implemented. For example, one or more such computing environments can be used as a server service and/or client device. Generally, various different computing system configurations can be used. Examples of well-known computing system configurations that may be suitable for use with the tools and techniques described herein include, but are not limited to, server farms and server clusters, personal computers, server computers, smart phones, laptop devices, slate devices, game consoles, multiprocessor systems, microprocessor-based systems, programmable consumer electronics, network PCs, minicomputers, mainframe computers, distributed computing environments that include any of the above systems or devices, and the like.

The computing environment 100 is not intended to suggest any limitation as to scope of use or functionality of the invention, as the present invention may be implemented in diverse types of computing environments.

With reference to FIG. 1, various illustrated hardware-based computer components will be discussed. As will be discussed, these hardware components may store and/or execute software. The computing environment 100 includes at least one processing unit or processor 110 and memory 120. In FIG. 1, this most basic configuration 130 is included within a dashed line. The processor 110 executes computer-executable instructions and may be a real or a virtual processor. In a multi-processing system, multiple processing units execute computer-executable instructions to increase processing power. The memory 120 may be volatile memory (e.g., registers, cache, RAM), non-volatile memory (e.g., ROM, EEPROM, flash memory), or some combination of the two. The memory 120 stores software 180 implementing property transfer transaction facilitation. An implementation of property transfer transaction facilitation may involve all or part of the activities of the processor 110 and memory 120 being embodied in hardware logic as an alternative to or in addition to the software 180.

Although the various blocks of FIG. 1 are shown with lines for the sake of clarity, in reality, delineating various components is not so clear and, metaphorically, the lines of FIG. 1 and the other figures discussed below would more accurately be grey and blurred. For example, one may consider a presentation component such as a display device to be an I/O component (e.g., if the display device includes a touch screen). Also, processors have memory. The inventors hereof recognize that such is the nature of the art and reiterate that the diagram of FIG. 1 is merely illustrative of an exemplary computing device that can be used in connection with one or more aspects of the technology discussed herein. Distinction is not made between such categories as “workstation,” “server,” “laptop,” “handheld device,” etc., as all are contemplated within the scope of FIG. 1 and reference to “computer,” “computing environment,” or “computing device.”

A computing environment 100 may have additional features. In FIG. 1, the computing environment 100 includes storage 140, one or more input devices 150, one or more output devices 160, and one or more communication connections 170. An interconnection mechanism (not shown) such as a bus, controller, or network interconnects the components of the computing environment 100. Typically, operating system software (not shown) provides an operating environment for other software executing in the computing environment 100, and coordinates activities of the components of the computing environment 100.

The memory 120 can include storage 140 (though they are depicted separately in FIG. 1 for convenience), which may be removable or non-removable, and may include computer-readable storage media such as flash drives, magnetic disks, magnetic tapes or cassettes, CD-ROMs, CD-RWs, DVDs, which can be used to store information and which can be accessed within the computing environment 100. The storage 140 stores instructions for the software 180.

The input device(s) 150 may be one or more of various different input devices. For example, the input device(s) 150 may include a user device such as a mouse, keyboard, trackball, etc. The input device(s) 150 may implement one or more natural user interface techniques, such as speech recognition, touch and stylus recognition, recognition of gestures in contact with the input device(s) 150 and adjacent to the input device(s) 150, recognition of air gestures, head and eye tracking, voice and speech recognition, sensing user brain activity (e.g., using EEG and related methods), and machine intelligence (e.g., using machine intelligence to understand user intentions and goals). As other examples, the input device(s) 150 may include a scanning device; a network adapter; a CD/DVD reader; or another device that provides input to the computing environment 100. The output device(s) 160 may be a display, printer, speaker, CD/DVD-writer, network adapter, or another device that provides output from the computing environment 100. The input device(s) 150 and output device(s) 160 may be incorporated in a single system or device, such as a touch screen or a virtual reality system.

The communication connection(s) 170 enables communication over a communication medium to another computing entity. Additionally, functionality of the components of the computing environment 100 may be implemented in a single computing machine or in multiple computing machines that are able to communicate over communication connections. Thus, the computing environment 100 may operate in a networked environment using logical connections to one or more remote computing devices, such as a handheld computing device, a personal computer, a server, a router, a network PC, a peer device, or another common network node. The communication medium conveys information such as data or computer-executable instructions or requests in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The tools and techniques can be described in the general context of computer-readable media, which may be storage media or communication media. Computer-readable storage media are any available storage media that can be accessed within a computing environment, but the term computer-readable storage media does not refer to propagated signals per se. By way of example, and not limitation, with the computing environment 100, computer-readable storage media include memory 120, storage 140, and combinations of the above.

The tools and techniques can be described in the general context of computer-executable instructions, such as those included in program modules, being executed in a computing environment on a target real or virtual processor. Generally, program modules include routines, programs, libraries, objects, classes, components, data structures, etc. that perform particular tasks or implement particular abstract data types. The functionality of the program modules may be combined or split between program modules as desired in various aspects. Computer-executable instructions for program modules may be executed within a local or distributed computing environment. In a distributed computing environment, program modules may be located in both local and remote computer storage media.

For the sake of presentation, the detailed description uses terms like “determine,” “choose,” “adjust,” and “operate” to describe computer operations in a computing environment. These and other similar terms are high-level descriptions for operations performed by a computer and should not be confused with acts performed by a human being unless performance of an act by a human being (such as a “user”) is explicitly noted. The actual computer operations corresponding to these terms vary depending on the implementation.

### II. Property Transfer Transaction Facilitation System and Environment

Communications between the various devices and components discussed herein can be sent using computer system hardware, such as hardware within a single computing device, hardware in multiple computing devices, and/or computer network hardware. A communication or data item may be considered to be sent to a destination by a component if that component passes the communication or data item to the system in a manner that directs the system to route the item or communication to the destination, such as by including an appropriate identifier or address associated with the destination. Also, a data item may be sent in multiple ways, such as by directly sending the item or by sending a notification that includes an address or pointer for use by the receiver to access the data item. In addition, multiple requests may be sent by sending a single request that requests performance of multiple tasks. Accordingly, receiving may include receiving items sent in such various ways.

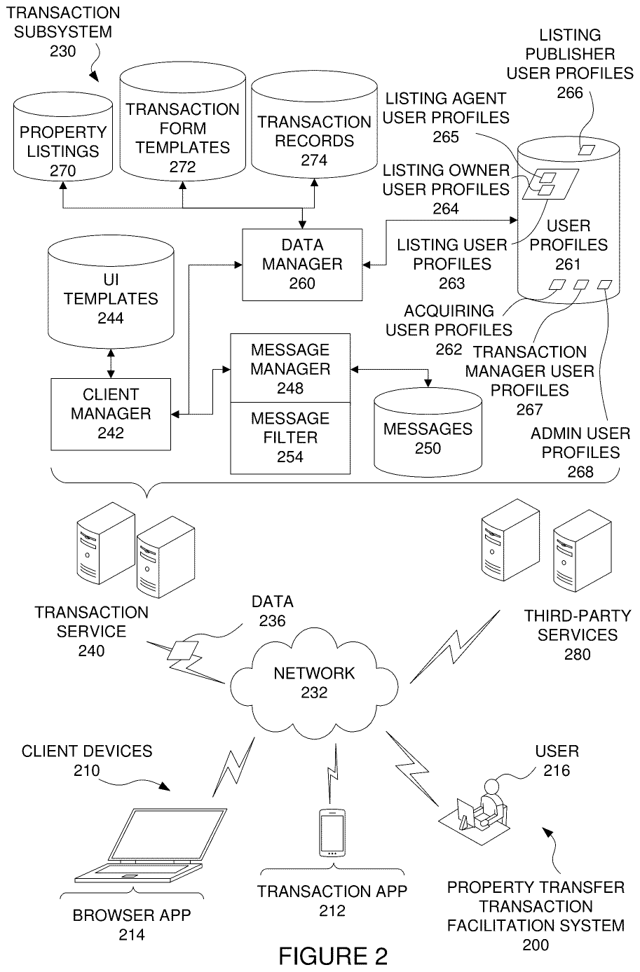

Referring now to FIG. 2, components of a property transfer transaction facilitation system 200 will be discussed. Each of the components includes hardware and may also include software. For example, a component of FIG. 2 can be implemented entirely in computer hardware, such as in a system on a chip configuration. Alternatively, a component can be implemented in computer hardware that is configured according to computer software and running the computer software. The components can be distributed across computing machines or grouped into a single computing machine in various ways. For example, a single component may be distributed across multiple different computing machines (e.g., with some of the operations of the component being performed on one or more client computing devices and other operations of the component being performed on one or more machines of a server).

The system 200 can include client devices 210. Each client device 210 can run a browser app 214 and/or a transaction app 212. A browser app 214 can be a browser that is configured to run to present and/or receive user input directed at browser pages such as webpages. The transaction app 212 can be a dedicated app that is configured to work as part of a transaction subsystem 230. The client devices 210 can be connected to other computers over a computer network 232, such as the Internet and/or other computer networks. For example, the client devices 210 can connect to a transaction service 240, which can be a server service that is part of the transaction subsystem 230. Some functions and/or data types discussed herein as being present in the transaction service 240 may instead be present in the client devices 210 and vice versa. The transaction service 240 can interact with the browser apps 214 and transaction apps 212 on the client devices 210 over the computer network 232, with data 236 being sent between the client devices 210 and the transaction service 240. Webpages served by the transaction service 240 and operating on browser apps 214 can also be part of the transaction subsystem 230.

The transaction service 240 can include a client manager 242, which can send data to and receive data from the client devices 210. For example, the client manager 242 can send data such as webpages and/or other user interface data to be presented using the browser apps 214 and transaction apps 212 on the client devices 210. Likewise, the client devices 210 running the browser apps 214 and the transaction apps 212 can send data, such as user input data, over the computer network 232 to the transaction service 240. The client manager 242 can manage UI templates 244 such as webpage templates and/or templates for user interface presentations for the transaction apps 212. The client manager 242 can populate the UI templates 244 with data and serve them as webpages or transaction app presentation data to the browser apps 214 and transaction apps 212 on the client devices 210.

The transaction service 240 can also include a message manager 248, which can manage the sending and storing of messages 250 being sent through the transaction subsystem 230. The transaction subsystem 230 can implement a message filter 254, which can limit messages sent through the transaction subsystem 230 using the message manager 248, such as based on prequalification values and listing values stored in the transaction service, as is discussed elsewhere in this disclosure.

The transaction service 240 can also include a data manager 260. The data manager 260 can manage different types of data stored in the transaction service 240. For example, the data manager 260 can manage user profiles 261. For example, the user profiles 261 can include acquiring user profiles 262, which can be user profiles 261 for users 216 that are to receive property in the property transfer transactions facilitated by the system 200. Also, the user profiles 261 can include listing user profiles 263, which can be user profiles 261 including listing owner user profiles 264 that have been verified as corresponding to owners of properties represented by the corresponding property listings 270 and/or listing agent user profiles 265 that correspond to agents of the owners of properties represented by the corresponding property listings 270. For example, listing owner user profiles 264 can be user profiles 261 for users 216 from which property is to be transferred in property transfer transactions facilitated by the system 200. The user profiles 261 can also include listing agent user profiles 265, which can be user profiles 261 for users 216 who are property agents representing users 216 of listing owner user profiles 264. The user profiles 261 can also include listing publisher user profiles 266, which can be user profiles 261 for users 216 who can take actions to publish listings on third party services other than the transaction service 240. For example, such publishing users (which may be groups of users) may be licensed brokers, such as where there is one (or possibly more than one) listing publisher user profile 266 for a corresponding licensed broker in each of multiple jurisdictions, such as in each of multiple states in the United States of America. The user profiles 261 may also include transaction manager user profiles 267, which can be profiles for transaction managers such as escrow agents/companies. The user profiles 261 may also include administrator user profiles 268, which can be profiles for administrators who maintain the transaction service 240 and/or perform various administrative functions (e.g., validating other user profiles 261 and/or property listings discussed below before they can be used in the transaction subsystem 230). The user profiles 261 may also include other user profiles, such as user profiles for third-party service providers related to the transactions, such as mortgage brokers/lenders, property appraisers, property inspectors, etc. In some examples, some user profiles may be used for multiple different user profile roles. For example, a single user profile 261 may be an acquiring user profile 262 for some properties and a listing user profile 263 for other properties. The user profiles 261 can each include data about the corresponding user 216 (which can be a group of users, or other entity or group of entities, as discussed above). For example, a user profile 261 may include contact information (email address, physical address, phone number, etc.), links to associated property listings and/or transactions involving the user profile, prequalification values for acquiring user profiles, user photographs, usernames, and passwords for the transaction subsystem 230, etc.

The data managed by the data manager 260 can also include property listings 270. The property listings 270 can include data regarding properties that are listed by listing user profiles for viewing by acquiring user profiles for possible transfer. For example, each property listing 270 may include textual data regarding the property (e.g., a listing value, an address for a real estate property, a size of the property and/or structures on the property, descriptions of features of the property, etc.) as well as photographs of the property. Each property listing 270 can also be linked to a user profile 261 that is the listing user profile for the listing (e.g., the data can include one or more references linking a corresponding user profile 261 and property listing 270 to each other).

The data managed by the data manager 260 may also include transaction form templates 272. The transaction form templates 272 can include templates for generating documents to be used in transactions. For example, the transaction form templates 272 can include templates for generating offer documents, counteroffer documents, agreement documents, addendum, or amendment documents, etc. For example, the transaction form templates 272 may include templates for real estate purchase contracts and addendums to such contracts. The transaction form templates 272 can be populated with other data in the transaction service 240, such as data from user profiles 261, property listings 270, and/or transaction records 274. In some implementations, such forms may be generated outside the transaction subsystem 230. For example, a real estate purchase agreement may be prepared by a third-party transaction manager and provided to the user of the listing user profile and the user of the acquiring user profile. Once the agreement has been signed, it may be sent to the transaction service 240 to be stored in a transaction record 274 for the corresponding transaction. For example, the transaction manager user profile 267 may be used to provide documents and other data such as status updates for a transaction, and such data can be stored in the corresponding transaction record 274.

The transaction records 274 can be records of specific property transfer transactions. Each transaction record 274 can be linked to a property listing 270 for the property to be transferred. A transaction record 274 can also be linked to one or more user profiles 261 such as to an acquiring user profile for a user that is to receive the property represented by the linked property listing 270, to a listing user profile for a user that is listing and transferring the property represented by the linked property listing 270, to a transaction manager user profile 267, and possibly to other data such as messages 250 for the transaction.

The system 200 can also include third-party services 280 that are not part of the transaction subsystem 230. Data 236 can be sent between the client devices 210 and the third-party services 280, and/or between the transaction service 240 and the third-party services 280. For example, the third-party services 280 can include property listing services. The transaction service 240 can send data from the property listings 270 to the property listing services so that those property listings can be presented by the third-party property listing services in addition to being presented by the transaction service 240. As discussed herein, the property listings 270 may be sent by the transaction service 240 to third-party services 280 via one or more listing publisher user profiles 266, which may involve receiving user input from the listing publisher user profiles 266, assigning the property listings 270 to the listing publisher user profiles 266, and/or using preferences stored as data in the listing publisher user profiles 266 to govern the sending of the property listings to the third-party services 280. Those presentations of the listings on the third-party property listing services can link back to the corresponding property listings in the transaction service 240. For example, a link in a third-party presentation of a property listing for contacting a person listing the property can link back to the property listing 270 in the transaction service 240, so that messaging of the listing user profile of the property listing can be managed by the message manager 248, including applying message filtering as discussed herein.

The third-party services 280 can also include services for service providers such as transaction managers, mortgage brokers and lenders, appraisers, inspectors, construction contractors, etc. that may perform work in association with a property transfer transaction. Data can be provided from the third-party services 280 to the transaction service 240 to update the transaction records 274 in the transaction service 240. Likewise, data can be provided from the transaction service 240 to the third-party services 280 to provide updates to the third-party services 280 regarding transactions. For example, such data may be sent using messaging services, application programming interface calls, and/or other data transfer techniques.

A system for property transfer transactions may be different than the system that is represented by FIG. 2 and discussed above. For example, different components of the system may be combined or distributed in different ways than what is illustrated in FIG. 2 and discussed above. As just one example, at least some functions and data storage performed by the transaction service 240 could be performed by the client devices 210 and vice versa.

The transaction subsystem 230 can be developed and implemented with various computer technologies. For example, front-end development technologies may include some combination of technologies such as technologies available under the names HTML/HTML 5, CSS 3, Bootstrap, jQuery/JavaScript, AngularJS, and/or ReactJS. Also, for an example, back-end development technologies may include technologies available under the name Nodejs. Also, for an example, mobile app development technologies may include technologies such as technologies available under the names Android (Native): Java & Kotlin; and/or iOS (Native): Swift. Also, for an example, database design technologies may include technologies available under the names DynamoDB.

### III. Property Transfer Transaction Facilitation Example

An example of property transfer transaction facilitation will now be discussed. In the example, a listing owner user profile 264 and/or a listing agent user profile 265 can be generated. For example, user input in a client device 210 can be sent as data 236 to the transaction service 240 requesting creation of the listing owner user profile 264 and/or listing agent user profile 265 and providing the data for populating the listing owner user profile 264 and/or listing agent user profile 265. For example, the transaction subsystem 230 may provide a form (e.g., on a webpage) to be filled in with user input on a client device 210, and in response to user input, the user input data can be sent to the transaction service 240 along with a request to create the listing owner user profile 264 and/or listing agent user profile 265. In the example, an acquiring user profile 262 can also be generated in a similar manner. Before generating or activating the user profiles, the user profiles may be validated, such as to ensure that the user profiles are being used by the users 216 they purport to represent. For example, this validation could include verifying identities using provided information and/or documents such as government issued identification documents. The validation could be performed automatically and/or by a user 216 of an administrator user profile 268. The one or more listing user profiles 263 (which may include a listing owner user profile 264 and/or a listing agent user profile 265) and the acquiring user profile 262 can be stored in the transaction service 240. As discussed above, the user profiles 261 can then be considered to perform actions in the system 200, as discussed above.

The listing owner user profile 264 or listing agent user profile 265 can request the generation or activation of a property listing 270 for a property owned by a user 216 of the listing owner user profile 264. The generation and activation of a property listing 270 can include retrieving data for the corresponding property from a source such as a government property record and retrieving data for the property from a listing user profile 263 (such as from a listing owner user profile 264 and/or from a listing agent user profile 265). The data from these sources can be compared and reconciled as part of generating the property listing. For example, data may be provided from the government source, and it may be corrected and supplemented by the transaction subsystem 230 using data from the listing user profile 263. Also, verification of the ownership of the property represented by the property listing 270 by the user 216 of the listing owner user profile 264 and/or verification of representation of the owner by an agent who is the user 216 of the listing agent user profile 265 may be performed. This may include verifying one or more forms of identification and/or indications of ownership provided by the listing owner user profile 264 and/or the listing agent user profile 265 (e.g., a government issued identification and/or a deed of property ownership), which may include comparing the provided documentation with reliable records such as government records of property ownership and/or government identification records. Also, the representation of the owner by the user 216 of the listing agent user profile 265 may be performed by requesting and receiving user input from the listing owner user profile 264 to verify such representation. This verification may be performed by manual and/or automated actions. For example, the verification may involve a user 216 of an administrative user profile 268 performing verification tasks and approving the verification.

In this example, the administrator user profile 268 can approve the verification by providing user input to a client device 210 to send the approval as data to the transaction service 240. An indication of approval for the listing owner user profile 264 as owner of the property listing 270 and/or for the listing agent user profile 265 as agent for the owner of the property listing 270 can then be entered in the transaction service 240, such as in the property listing 270 and/or in the user profiles 261 including the listing owner user profile 264 and/or the listing agent user profile 265. As part of the listing approval process, the listing owner user profile 264 and/or the listing agent user profile 265 may be required to agree to an agreement with the operator of the transaction subsystem 230. For example, the agreement may indicate that in return for the services of the transaction subsystem 230, the operator of the subsystem is entitled to a percentage of a sale price for the transfer of the property represented by the property listing 270. Alternatively, other forms of compensation may be provided for use of the transaction subsystem.

The property listing 270 can then be published by the transaction subsystem, and possibly also sent to third-party services 280 that are property listing services for publication of the listing, as discussed above. For example, the transaction service 240 may determine that the property listing 270 is to be sent to third-party services 280 for listing publication via a specific listing publisher user profile 266. Each listing publisher user profile 266 may include data indicating which types of property listings 270 will be sent to third-party services 280 via that listing publisher user profile 266. For example, that data may indicate a geographic region or jurisdiction, such as one or more cities, counties, states, and/or countries for which property listings 270 will be sent for publication via that listing publisher user profile 266. And each property listing 270 can include data that can be analyzed to determine whether that property listing 270 matches the corresponding data in the listing publisher user profile 266. For example, a property listing 270 can include physical address data, and a listing publisher user profile 266 can include data specifying California, which is a state in the United States of America for which property listings 270 are to be sent for publication via that listing publisher user profile 266. The transaction service 240 can compare the physical address data to see if it is a match for the property listing 270 by determining whether the address data for the property listing 270 lists California as the state where the property is located. If so, then the transaction service 240 can notify that matching listing publisher user profile 266 that the property listing 270 is assigned to it (such as by sending an electronic message as discussed herein) and can send the property listing 270 to third-party services 280 that are property listing services. The transaction service 240 may request and receive confirmation from the listing publisher user profile 266 that the property listing should be sent before sending the property listing to the third-party services 280 for publishing the listing via the third-party services 280 (also referred to as listing the property on the third-party services 280). Thus, the sending may be performed in response to receiving confirmation from the assigned listing publisher user profile 266. The sending of a property listing 270 to a third-party service 280 may include sending data 236 such as in an application programming interface call or as part of some other type of digital transmission. Such data may be sent directly to the third-party service 280, or it may be sent to the listing publisher user profile 266, and a listing publisher for the listing publisher user profile may take actions to send the data to the third-party service 280.

The published listings in the third-party services 280 for the property listings 270 from the transaction service 240 can include links back to the transaction service 240. For example, a link for contacting a listing owner or agent on a third-party service 280 may link back to the transaction service 240. Specifically, the link may be formatted (such as by being a specific URL associated with a resource such as computer code managed by the transaction service 240) so that the system responds to its selection by prompting the transaction service 240 to perform its messaging techniques for an acquiring user profile 262 seeking to message or otherwise contact a listing owner user profile 264 and/or a listing agent user profile 265. For example, this may include having the potential acquiring user create an acquiring user profile 262 with the transaction service 240 and verifying that the potential acquiring user is qualified for the particular property listing 270 using the data in the acquiring user profile 262 as discussed herein.

As discussed above, in some situations a property listing 270 can be associated with a listing user profile 263, but not with a listing agent user profile 265. In such situations, messages and actions discussed herein as being associated with the listing user profile 263 (which can include the listing owner user profile 264 and/or the listing agent user profile 265) can be associated with the listing owner user profile 264. In other situations, a property listing 270 can be associated with a listing owner user profile 264 and a listing agent user profile 265. In such situations, messages and actions discussed herein as being associated with the listing user profile 263 (which can include the listing owner user profile 264 and/or the listing agent user profile 265) can be associated with either of these profiles or with both, depending on the context. For example, a message described as being received by the listing owner user profile 264 and/or the listing agent user profile 265 may be received by the listing user profile 263, by the listing agent user profile 265, or by both these user profiles. And if a message is described as being sent by the listing owner user profile 264 and/or the listing agent user profile 265, the message would typically be sent by either the listing owner user profile 264 or the listing agent user profile 265 (though it is possible a message my require user input consent via the listing owner user profile 264 and the listing agent user profile 265, so it could be considered to be send by both).

Also, the transaction service 240 can handle messages being sent between the listing agent user profile 265 and the listing owner user profiles 264 represented by that listing agent user profile 265 for associated property listings 270. Such messages can be associated with the corresponding property listings 270 to which they pertain. The transaction service 240 can also handle documents to be signed by the listing agent user profiles 265 and/or the listing owner user profiles 264 they represent. For example, the transaction service 240 can facilitate the signing of documents by the listing agent user profiles 265 and the listing owner user profiles 264 for agreements between them. As another example, if a document needs to be signed by a listing owner user profile 264, a listing agent user profile 265 may draft and send a message to the listing owner user profile 264 via the transaction service, and that message may include a link that the listing owner user profile 264 can select to invoke a document signing service, which may be a third-party service 280 or an internal document signing service provided by the transaction service 240.

The acquiring user profile 262 can browse the property listings 270 from the transaction subsystem. For example, the acquiring user profile 262 may perform a search of the property listings 270, such as by indicating a geographic area, a range of values of listings, a desired property size, and/or other search criteria. Using such criteria, the transaction subsystem can invoke a search algorithm to identify property listings 270 that meet the criteria. For example, this may be done using a search index that is generated from the property listings 270 and used for conducting searches. The acquiring user profile 262 can view the search results, such as a list of property listings 270 with limited displayed data about each listing and may click on a result representing the property listing discussed above. In response to this user input, data 236 may be provided to the transaction service 240 requesting the display of the selected property listing 270. In response, the client manager 242 can retrieve the property listing 270 from the data manager 260 and can populate a property listing UI template 244 with that property listing data. The client manager 242 can send this resulting user interface response to the client device 210 where the acquiring user profile 262 is active (for example, this may include sending a webpage or sending data for a page of a transaction app 212).

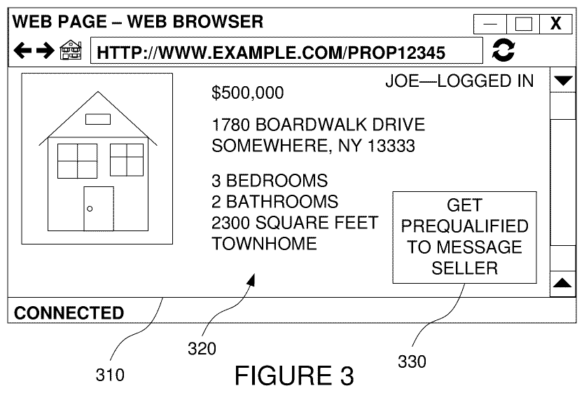

Referring to FIG. 3, an example is illustrated of a display 310 on a client device 210 illustrating a property listing 270. Displays of property listings 270 can be formatted in different ways and include different data, so it should be appreciated that this example is for convenience in this discussion. Nevertheless, in this example, the display 310 includes displayed property data 320, such as a listing value ($500,000), an address of the property represented by the listing, text describing features of the property (such as the number of bedrooms, number of bathrooms, square feet in the house, and an indication of the type of property (townhome)), and an illustration representing a photograph of the property. The display 310 can also include a user interface control 330 indicating the acquiring user profile 262 does not include a prequalification value range that includes the listing value of the property listing 270. The user interface control 330 can be selected by user input to forward the app on the client device 210 to a site for a third-party service 280, which can provide prequalification services for the user 216 of the acquiring user profile 262. For example, the user interface control 330 may be a hyperlink that includes a uniform resource locator for a webpage provided by the third-party service 280, such as a lender or mortgage agent. The third-party service 280 can request information for the prequalification and analyze the provided information, which may be provided to the third-party service 280 through user input to the client device 210 by the user 216 of the acquiring user profile 262. The prequalification service provided by the third-party service 280 may be entirely automated, or it may involve users 216 that are administrators or staff of the third-party service 280. Either way, the third-party service 280 and/or associated personnel can determine whether to prequalify the user 216 of the acquiring user profile 262, and the value range of that prequalification if the prequalification is approved. The third-party service 280 can then send data 236 to the client device 210 of the user 216 of the acquiring user profile 262 indicating a value range for the prequalification (e.g., up to $600,000).

After pre-approval, the third-party service 280 can also send data 236 to the transaction service 240 indicating that value range for the acquiring user profile 262. The transaction service 240 can respond by storing data indicating that value range in the transaction service 240, such as in the acquiring user profile 262. The third-party service 280 can then use that value range to format the message filter 254 for that acquiring user profile 262 to facilitate messaging using the message manager 248 from the acquiring user profile 262 to listing owner user profiles 264 and/or listing agent user profiles 265 of property listings 270 having listing values that are within the range of the prequalification value for the acquiring user profile 262. For example, when the acquiring user profile 262 browses to a property listing 270, the transaction service 240 can compare the prequalification value range for the acquiring user profile 262 with the listing value of the property listing 270. If the listing value of the property listing 270 is within the prequalification value of the acquiring user profile 262, then the transaction service 240 can facilitate messaging from the acquiring user profile 262 to the listing owner user profile 264 and/or the listing agent user profile 265 of the associated property listing 270.

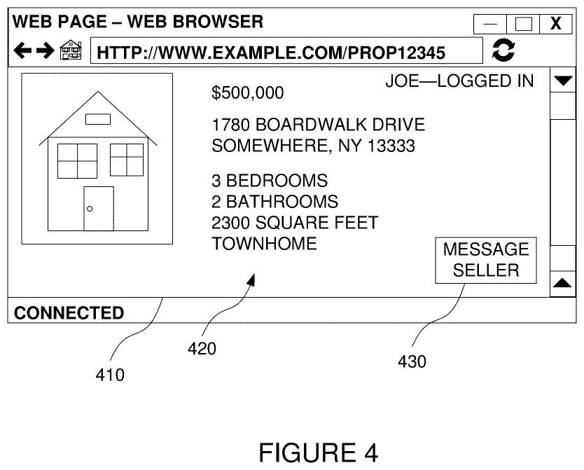

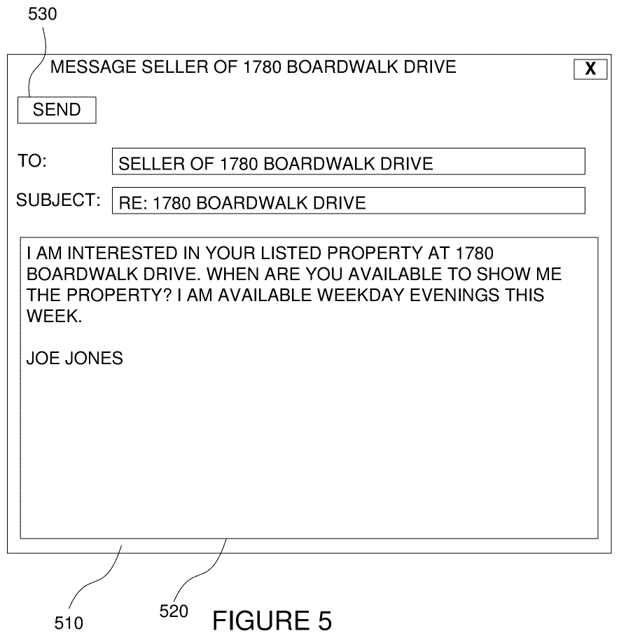

In the example, if the acquiring user profile 262 now has a prequalification value range up to $600,000 and the listing value of the property listing 270 is $500,000, then the transaction subsystem 230 can facilitate messaging from the acquiring user profile 262 to the listing owner user profile 264 and/or the listing agent user profile 265 of the property listing 270. Thus, when the acquiring user profile 262 browses back to the property listing of FIG. 3, the display can be changed to the display 410 illustrated in FIG. 4. The display 410 can still include the displayed property data 420. But instead of the user interface control 330 indicating the acquiring user profile 262 is not prequalified for the listing amount of the property listing 270, the display 410 can include a messaging user interface control 430 that can be selected by user input to initiate messaging from the acquiring user profile 262 to the listing owner user profile 264 and/or the listing agent user profile 265 of the property listing 270. For example, user input selection of the messaging user interface control 430 can prompt the transaction subsystem 230 to provide and present a message display 510 such as the one illustrated in FIG. 5 or some other message display. The message display 510 can be formatted with controls such as text boxes 520 for receiving user input for the message to be sent. The message display 510 can also include a sending user interface control 530 that can be selected by user input to prompt the transaction subsystem 230 to send the indicated message to the listing owner user profile 264 and/or the listing agent user profile 265 for the property listing 270. The transaction subsystem 230 can then notify the listing owner user profile 264 and/or the listing agent user profile 265 that it has received a message and can provide the message to the listing owner user profile 264 and/or the listing agent user profile 265. The transaction subsystem 230 can also facilitate additional messages between the acquiring user profile 262 and the listing owner user profile 264 and/or the listing agent user profile 265. For example, the messages may discuss terms to be included in an agreement for the transfer of the property represented by the property listing 270.

Once the acquiring user profile 262 and the listing owner user profile 264 are ready to enter an agreement such as a real estate purchase contract, one or both of the user profiles (and/or the listing agent user profile 265) can indicate this to the transaction subsystem 230. The transaction subsystem 230 can respond by initiating a technique for generating and signing the agreement.

Initiating the technique for generating and signing the agreement may include invoking a third-party service 280 for generating the transfer agreement and obtaining signatures for the transfer agreement. For example, once the acquiring user profile 262 and the listing owner user profile 264 are ready to enter an agreement such as a real estate purchase contract, one or both of the user profiles (and/or the listing agent user profile 265) can indicate this to the transaction subsystem 230. The transaction subsystem 230 can respond by connecting the acquiring user profile 262 and the listing owner user profile 264 and/or the listing agent user profile 265 (and/or the associated users 216) with a transaction manager third-party service 280. The transaction manager third-party service 280 (and/or the listing agent user profile 265 if one is involved) can generate the agreement using input from the acquiring user profile 262 and the listing user profile 263 and/or the associated users. The transaction subsystem 230 may also send data 236 to the transaction manager third-party service 280 (and/or to the listing agent user profile 265) to be used in generating the agreement. For example, such data may include data from the associated property listing 270 and from the acquiring user profile 262 and the listing user profile 263. Also, the transaction subsystem 230 can generate a transaction record 274 for facilitating the transaction to transfer the property represented by the property listing 270 from the user 216 of the listing owner user profile 264 to the user 216 of the acquiring user profile 262.

The transaction can then proceed, with the transaction subsystem 230 tracking progress of the transaction in the transaction record 274, and with the transaction manager third-party service 280 managing the transaction. The transaction manager third-party service 280 can send data 236 to the transaction service 240 to update the transaction record 274 on the current status of the transaction, and to provide documentation of the transaction. In some implementations, this can include personnel of the agent third-party service 280 having a transaction manager user profile 267 that can be logged into the transaction subsystem 230 to provide the updates. In other implementations, the third-party service 280 may provide updates and documentation to the transaction service 240 in other ways, such as by sending data 236 to the transaction service 240 (e.g., through application programming interface calls or other data transmission techniques).

The transaction subsystem 230 can provide the acquiring user profile 262, the listing owner user profile 264, and/or the listing agent user profile 265 with links (such as hyperlinks in displays, or possibly just providing contact information) to service providers that can provide services related to the transaction to the acquiring user profile 262 and the listing user profile 263. Such service providers may agree to provide services to users of the transaction subsystem 230 at reduced rates in exchange for being listed as service providers by the transaction subsystem 230. And the service providers may provide compensation to the operator of the transaction subsystem 230. The provider of the transaction manager third-party service 280 may receive updates and documentation from the third-party service providers and can send those updates and documentation as data to the transaction service 240 to be stored in the transaction records 274. Alternatively, the service providers and/or the acquiring user profile 262, the listing owner user profile 264, and/or the listing agent user profile 265 could provide the updates and documentation regarding actions taken by third-party service providers to the transaction service 240. For example, the service providers could have user profiles 261 in the transaction subsystem 230 that could allow them to log in and send data 236 to the transaction service 240. However the updates and documentation are provided, the transaction records 274 can include data for status updates and documentation for the transaction.

As some examples of updates and documentation, the transaction records 274 may include a real estate purchase contract and addendums or amendments to the real estate purchase contract, as well as indications of dates from the real estate purchase contract (e.g., a due diligence deadline, a financing deadline, a date for settlement and/or closing, etc.). The transaction service 240 can track dates for the transaction and can send notices of such dates to the relevant parties, such as to the acquiring user profile 262, the listing owner user profile 264, and/or the listing agent user profile 265 for the transaction. A transaction record 274 can also include an indication that an inspection has been scheduled and a date for the inspection, an indication that an inspection has been performed after it has been performed, and an inspection report after the report has been submitted. Similarly, a transaction record 274 can include an indication that an appraisal has been scheduled and a date for the appraisal, an indication that an appraisal has been performed after it has been performed, and an appraisal report after the report has been submitted. As other examples, a transaction record 274 can include an indication of the status of a loan application for the user 216 of the acquiring user profile 262 to obtain a loan for providing funds in exchange for the property transfer. For example, a transaction record 274 may indicate whether the user 216 of the acquiring user profile 262 has been preapproved for the loan, whether the acquiring user profile 262 has been approved for the loan, and whether the funds for the loan have been provided, such as provided to the transaction manager. The transaction records may also indicate when signed closing documents have been received by the transaction manager, when the funds for the transaction have been provided to the transaction manager, when the funds for the transaction have been transmitted to the user 216 of the listing user profile 263, and when a deed or bill of sale for the property transfer has been recorded with a government entity. Documentation in the transaction record may also include closing documents for the transaction, including signed documents. Accordingly, the transaction subsystem 230 can use the data in the transaction record to provide status updates and documentation to user profiles 261, such as in the form of digital status updates indicating the types of status updates discussed above, and/or other status updates. The user profiles 261 may be able to access and download the documentation from transaction records 274 linked to them while the transactions are ongoing, or even after the transactions have concluded. For example, such access and downloading may be useful later when the users 216 of the user profiles 261 need the documents from the transaction records 274, such as for government tax filings.

Also, as the transaction proceeds, the transaction service 240 may provide updates to property listings 270 on the transaction service 240, and the transaction service 240 may also send such updates to the corresponding listings that are published on third-party services 280. Such updates may be provided automatically in response to updates to property listings 270 without additional user input. Or such updates may be provided in response to confirming user input after such updates are made to the property listings 270. For example, if an update is made to a property listing 270 (e.g., an updated listing price, an updated status from listed to pending, or from pending to sold), a message may be sent to the corresponding listing owner user profile 264, listing agent user profile 265, and/or listing publisher user profile 266 assigned to the property listing. That message may request confirmation from one or more of those user profiles. And once the requested confirmation is received by the transaction service 240, such as from user input or an automated response from the user profile(s), the transaction service 240 can respond by sending the updates to the third-party services 280 in a manner similar to the sending of the property listings to the third-party services 280 for publication (e.g., using application programming interface calls or other digital transmissions).

### IV. Property Transfer Transaction Facilitation Techniques

Several property transfer transaction facilitation techniques will now be discussed. Each of these techniques can be performed in a computing environment. For example, each technique may be performed in a computer system that includes at least one processor and memory including instructions stored thereon that when executed by at least one processor cause at least one processor to perform the technique (memory stores instructions (e.g., object code), and when processor(s) execute(s) those instructions, processor(s) perform(s) the technique). Similarly, one or more computer-readable memory may have computer-executable instructions embodied thereon that, when executed by at least one processor, cause at least one processor to perform the technique. The techniques discussed below may be performed at least in part by hardware logic. Features discussed in each of the techniques below may be combined with each other in any combination not precluded by the discussion herein, including combining features from a technique discussed with reference to one figure in a technique discussed with reference to a different figure. Also, a computer system may include means for performing each of the acts discussed in the context of these techniques, in different combinations.

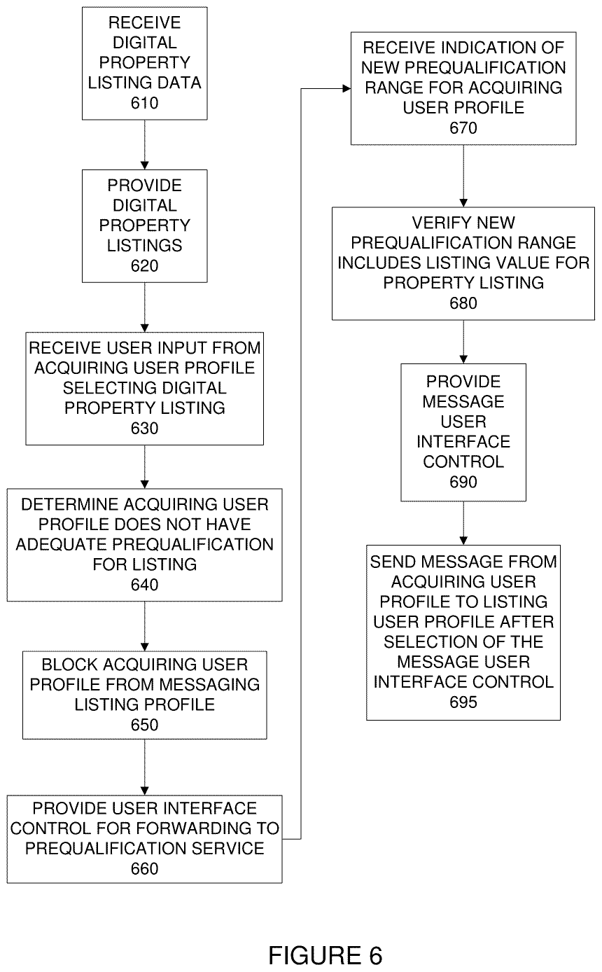

Referring to FIG. 6, a property transfer transaction facilitation technique will be described. The technique can include receiving 610 digital property listing data from listing user profiles. The listing user profiles may include user profiles that have been verified as corresponding to owners of properties represented by the digital property listing data and/or their agents. The technique can also include using the digital property listing data to provide 620 digital property listings to acquiring user profiles (which may include sending over a computer network). The technique can also include receiving 630 user input from an acquiring user profile selecting a digital property listing (which may include receiving input at a device and/or over a network where the device has been input via a user input device such as those discussed herein); and determining 640 that the acquiring user profile does not have a current prequalification value range in the computer system that includes a listing value of the digital property listing (which may include accessing data and analyzing it to determine whether the acquiring user profile has a current prequalification value range stored in the system, and if so, comparing that value range to a listing value of the digital property listing, which can also be stored in the system). The technique can also include, in response to determining that the acquiring user profile does not have a current prequalification value range in the computer system that includes the listing value of the digital property listing, performing the following: blocking 650 the acquiring user profile from messaging a listing user profile for the digital property listing through a messaging user interface control in the digital property listing (for example, this can include not providing an activated user interface control that could be used to initiate such messaging (such as only including an inactive user interface control or not providing a user interface control)); and providing 660 a user interface control that is selectable to forward the acquiring user profile to a prequalification service (such as providing the user interface control on a webpage or as data for a page of a dedicated transaction app). Additionally, the technique can include receiving 670 from the prequalification service an indication of a new prequalification range for the acquiring user profile (such as receiving in a message, as data from a prequalification service user profile logged into the transaction service, or in an application programming interface call); and verifying 680 that the new prequalification range includes the listing value of the digital property listing (such as by comparing the new prequalification range now stored in the system with the stored listing value of the digital property listing). Also, the technique can include, in response to verifying that the new prequalification range includes the listing value of the digital property listing, providing 690 the acquiring user profile with a message user interface control associated with the digital property listing (such as providing the message user interface control on a webpage or as data for use in a page of a dedicated transaction app), the message user interface control being selectable to initiate sending a digital message from the acquiring user profile to the listing user profile. And the technique can include sending 695 a message from the acquiring user profile to the listing user profile after selection of the message user interface control (for example, this messaging may include linking a message to the listing user profile and notifying the user profile of the presence of the message in the system, and/or sending the message using a messaging service such as SMS or email).

In the technique, the listing user profiles can include listing agent user profiles, and the listing user profile can include a listing agent user profile, where the technique can include verifying that the listing agent user profile corresponds to an agent of an owner of the digital property listing. Also, the listing user profiles can include listing owner user profiles, and the listing user profile can be a listing owner user profile, where the technique can include verifying that the listing owner user profile corresponds to an owner of the digital property listing.

The technique can also include storing the new prequalification range in a computer subsystem, and the sending of the message from the acquiring user profile to the listing user profile after selection of the message user interface control can be facilitated by the computer subsystem.

The technique can be part of an end-to-end facilitation of a transaction that transfers a property represented by the digital property listing from a user of the listing user profile to a user of the acquiring user profile. Also, the technique can further include continuing facilitation of the transaction until the transaction transfers the property represented by the digital property listing. The facilitation can include interacting with the listing user profile and the acquiring user profile. Also, in some situations, the facilitation can preclude interacting with property agents of the user of a listing owner user profile or property agents of the user of the acquiring user profile. In other situations. The facilitation can include facilitating interaction with property agents of the user of the listing owner user profile. The facilitation can include interacting with one or both of a transaction manager user profile and a transaction manager computer service of a transaction manager that oversees at least a part of the transaction and provides updated data into the computer system regarding the transaction. The facilitation may include providing a single computer subsystem with status updates for multiple events in the transaction that involve multiple different service providers.

The technique may further include sending the digital property listings to one or more third-party property listing services. The sending of the digital property listings to the one or more third-party property listing services can be performed via at least one publisher user profile.

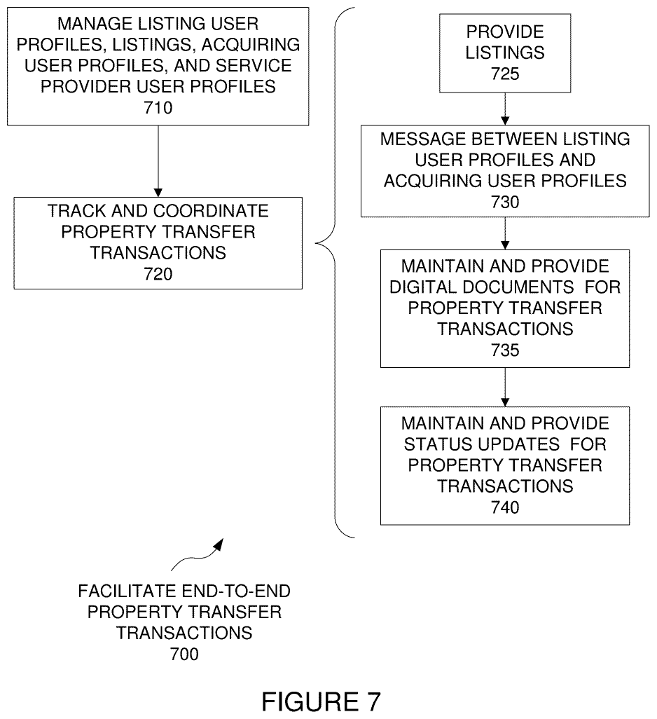

Referring to FIG. 7, another property transfer transaction facilitation technique will be described. The technique can include facilitating 700, via a computer subsystem, end-to-end property transfer transactions. The facilitating 700 can include managing 710 listing user profiles, digital property listings of the listing user profiles, acquiring user profiles, and service provider user profiles (which may include receiving, storing, editing, and/or retrieving the user profiles in the system). The facilitating 700 can also include, at a single available computer subsystem, tracking and coordinating 720 the property transfer transactions from listing of properties represented by the digital property listings to completion of transfers of properties represented by the digital property listings from listing users represented by the listing user profiles to acquiring users represented by acquiring user profiles. The tracking and coordinating 720 can include providing 725 digital property listings representing properties available for transfer (e.g., providing on webpages and/or in data for pages for a dedicated transaction app); messaging 730 between the listing user profiles and the acquiring user profiles, the messaging including limiting messages from acquiring user profiles to listing user profiles to only be from acquiring user profiles with digital indications of prequalification value ranges that include listing values of digital property listings of listing user profiles to whom the messages are to be sent, where the listing user profiles may include one or more listing agent user profiles that correspond to agents of owners of properties represented by one or more of the digital property listings; maintaining and providing 735 digital documents for the property transfer transactions (which can include receiving, storing, editing, retrieving, populating, and/or sending the documents, such storing and sending to user profiles an already-completed document received from a third party, or providing and possibly populating a template for a listing profile or acquiring profile to generally indicate an offer acceptance prior to signing a purchase contract); and maintaining and providing 740 status updates for the property transfer transactions (which can include receiving, storing, editing, retrieving, populating, and/or sending the documents).

The facilitating 700 can further include sending the digital property listings to one or more third-party property listing services via at least one listing publisher user profile.

The facilitating 700 can further include receiving user input from an acquiring user profile selecting a digital property listing; and, in response to receiving the user input directed at the digital property listing, determining that the acquiring user profile does not have a current digital prequalification value range that includes a listing value of the digital property listing. The facilitating 700 can also include, in response to determining that the acquiring user profile does not have a current digital prequalification value range that includes the listing value of the digital property listing, performing the following: blocking the acquiring user profile from messaging a listing user profile for the digital property listing through a messaging user interface control in the digital property listing, where the listing user profile may be a listing agent user profile, with data in the computer subsystem (such as data in the listing agent user profile, the digital property listing, and/or a listing owner user profile for the digital property listing) indicating that the listing agent user profile corresponds to a property agent of an owner of a property represented by the digital property listing; and providing in association with the digital property listing a user interface control that is selectable to forward the acquiring user profile to a prequalification service. The facilitating 700 can also include receiving from the prequalification service an indication of a new prequalification range for the acquiring user profile; in response to verifying that the new prequalification range includes the listing value of the digital property listing, presenting the acquiring user profile with a message user interface control associated with the digital property listing, the message user interface control being selectable to initiate sending a digital message from the acquiring user profile to the listing user profile; and sending a message from the acquiring user profile to the listing user profile after selection of the message user interface control.

The technique can include storing the new prequalification range in a computer subsystem, wherein the sending of the message from the acquiring user profile to the listing user profile after selection of the message user interface control can be facilitated by the computer subsystem. The computer subsystem can store, maintain, and provide status data representing a status of a process for transferring a property represented by the digital property listing from a user of the listing user profile to a user of the acquiring user profile. The computer subsystem can provide the listing user profile and the acquiring user profile with status updates from the status data.

The facilitating 700 can further include sending multiple messages between the listing user profile and the acquiring user profile. The multiple messages can include discussions of terms of an agreement for transferring a property represented by the digital property listing from a user of the listing user profile to a user of the acquiring user profile.

The maintaining and providing 735 status updates for the property transfer transactions can include maintaining status updates for transferring a property represented by the digital property listing from a user of a listing user profile to a user of an acquiring user profile; and providing the listing user profile and the acquiring user profile with the status updates for transferring the property represented by the digital property listing from the user of the listing user profile to the user of the acquiring user profile.

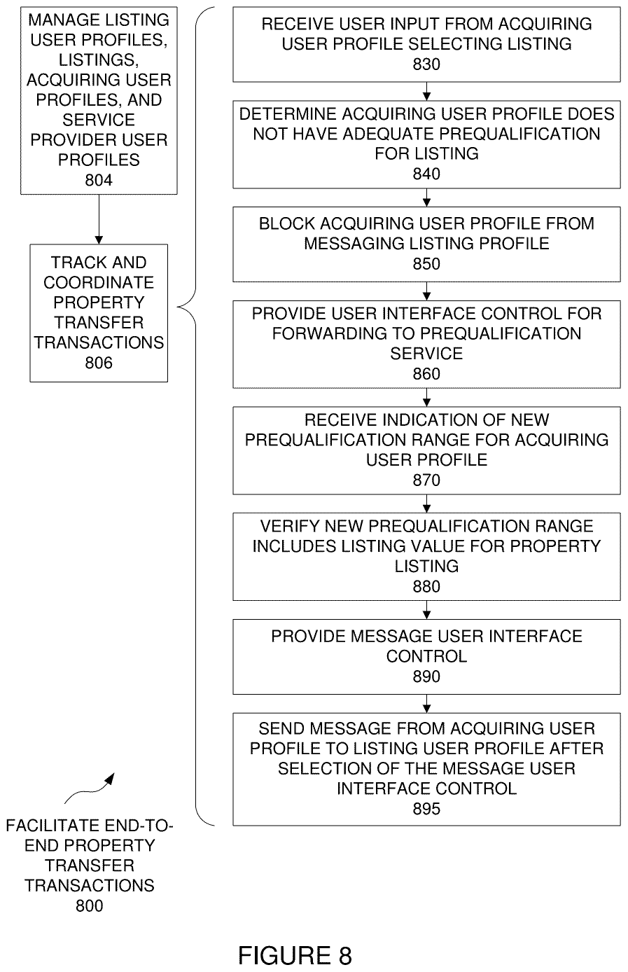

Referring to FIG. 8, another property transfer transaction facilitation technique will be described. The technique can include facilitating 800, via a computer subsystem, end-to-end property transfer transactions. The facilitating 800 can include managing 804 listing user profiles (which may include listing owner user profiles and/or listing agent user profiles), digital property listings of the listing user profiles, acquiring user profiles, and service provider user profiles; and, at a single available computer subsystem, tracking and coordinating 806 the property transfer transactions from listing of properties represented by the digital property listings to completion of transfers of the properties represented by the digital property listings from listing users represented by the listing user profiles to acquiring users represented by acquiring user profiles. The tracking and coordinating 806 can include receiving 830 user input from an acquiring user profile selecting a digital property listing; and in response to receiving the user input directed at the digital property listing, determining 840 that the acquiring user profile does not have a current digital prequalification value range that includes a listing value of the digital property listing. The tracking and coordinating 806 can also include, in response to determining 840 that the acquiring user profile does not have a current digital prequalification value range that includes the listing value of the digital property listing, performing the following: blocking 850 the acquiring user profile from messaging a listing user profile of the digital property listing through a messaging user interface control in the digital property listing; and providing 860 in association with the digital property listing a user interface control that is selectable to forward the acquiring user profile to a prequalification service. The tracking and coordinating 806 can further include receiving 870 from the prequalification service an indication of a new prequalification range for the acquiring user profile; verifying 880 that the new prequalification range includes the listing value of the digital property listing; in response to verifying that the new prequalification range includes the listing value of the digital property listing, providing 890 the acquiring user profile with a message user interface control associated with the digital property listing, the message user interface control being selectable to initiate sending a digital message from the acquiring user profile to the listing user profile; and sending 895 a message from the acquiring user profile to the listing user profile after selection of the message user interface control.

The tracking and coordinating 806 can further include sending multiple messages between the listing user profile and the acquiring user profile. The multiple messages can include an offer and an acceptance of an agreement for transferring a property represented by the digital property listing from a user of the listing user profile to a user of the acquiring user profile.

The tracking and coordinating 806 can further include tracking a status of a process leading to transfer of a property represented by the digital property listing from a user of the listing user profile to a user of the acquiring user profile. The tracking of the status can include tracking actions taken by multiple service providers and providing status updates to the listing user profile and to the acquiring user profile.

The tracking and coordinating 806 can further include receiving status updates from a transaction manager user profile for transferring of a property represented by the digital property listing from a user of the listing user profile to a user of the acquiring user profile.

The tracking and coordinating can further include storing the new prequalification range in a computer subsystem. The sending of the message from the acquiring user profile to the listing user profile after selection of the message user interface control can be facilitated by the computer subsystem.

The facilitating may further include sending the digital property listings to one or more third-party property listing services via at least one listing publisher user profile.

The technique can include indicating that the listing owner user profiles correspond to owners of properties represented by the digital property listings and indicating that the listing agent user profiles correspond to agents of owners of properties represented by the digital property listings.

The listing user profile can be a listing agent user profile corresponding to an agent of an owner of the digital property listing.

The technique can further include sending the message to a listing owner user profile corresponding to the owner of the digital property listing.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

I/We claim:

1. A computer system comprising:
at least one processor; and
memory comprising instructions stored thereon that when executed by at least one processor cause at least one processor to perform acts comprising:
receiving digital property listing data from listing user profiles;
using the digital property listing data to provide digital property listings to acquiring user profiles;
receiving user input from an acquiring user profile selecting a digital property listing;
determining that the acquiring user profile does not have a current prequalification value range in the computer system that includes a listing value of the digital property listing;
in response to determining that the acquiring user profile does not have a current prequalification value range in the computer system that includes the listing value of the digital property listing, performing the following:
blocking the acquiring user profile from messaging a listing user profile for the digital property listing through a messaging user interface control in the digital property listing; and
providing a user interface control that is selectable to forward the acquiring user profile to a prequalification service;
receiving from the prequalification service an indication of a new prequalification range for the acquiring user profile;
verifying that the new prequalification range includes the listing value of the digital property listing;
in response to verifying that the new prequalification range includes the listing value of the digital property listing, providing the acquiring user profile with a message user interface control associated with the digital property listing, the message user interface control being selectable to initiate sending a digital message from the acquiring user profile to the listing user profile; and
sending a message from the acquiring user profile to the listing user profile after selection of the message user interface control.

2. The computer system of claim 1, wherein the listing user profiles comprise listing agent user profiles, and wherein the listing user profile comprises a listing agent user profile, and wherein the acts comprise verifying that the listing agent user profile corresponds to an agent of an owner of the digital property listing.

3. The computer system of claim 1, wherein the listing user profiles comprise listing owner user profiles, wherein the listing user profile comprises a listing owner user profile, and wherein the acts comprise verifying that the listing owner user profile corresponds to an owner of the digital property listing.

4. The computer system of claim 1, wherein the acts include storing the new prequalification range in a computer subsystem, and wherein the sending of the message from the acquiring user profile to the listing user profile after selection of the message user interface control is facilitated by the computer subsystem.

5. The computer system of claim 1, wherein the acts are part of an end-to-end facilitation of a transaction that transfers a property represented by the digital property listing from a user of the listing user profile to a user of the acquiring user profile, and wherein the acts further include continuing facilitation of the transaction until the transaction transfers the property represented by the digital property listing.

6. The computer system of claim 5, wherein the facilitation includes interacting with one or both of a transaction manager user profile and a transaction manager computer service of a transaction manager that oversees at least a part of the transaction and provides updated data into the computer system regarding the transaction.

7. The computer system of claim 5, wherein the facilitation includes providing a single computer subsystem with status updates for multiple events in the transaction that involve multiple different service providers.

8. The computer system of claim 1, wherein the acts further comprise sending the digital property listings to one or more third-party property listing services, and wherein the sending of the digital property listings to the one or more third-party property listing services is performed via at least one listing publisher user profile.

9. A computer-implemented method, comprising:
facilitating, via a computer subsystem, end-to-end property transfer transactions, the facilitating comprising:
managing listing user profiles, digital property listings of the listing user profiles, acquiring user profiles, and service provider user profiles;
at a single available computer subsystem, tracking and coordinating the property transfer transactions from listing of properties represented by the digital property listings to completion of transfers of properties represented by the digital property listings from listing users represented by the listing user profiles to acquiring users represented by acquiring user profiles, the tracking and coordinating comprising:
providing digital property listings representing properties available for transfer;
messaging between the listing user profiles and the acquiring user profiles, the messaging comprising limiting messages from acquiring user profiles to listing user profiles to only be from acquiring user profiles with digital indications of prequalification value ranges that include listing values of digital property listings of listing user profiles to whom the messages are to be sent, wherein the listing user profiles comprise one or more listing agent user profiles that correspond to agents of owners of properties represented by one or more of the digital property listings;
maintaining and providing digital documents for the property transfer transactions; and
maintaining and providing status updates for the property transfer transactions.

10. The method of claim 9, wherein the facilitating further comprises sending the digital property listings to one or more third-party property listing services via at least one listing publisher user profile.

11. The method of claim 9, wherein the facilitating further comprises:
receiving user input from an acquiring user profile selecting a digital property listing;
in response to receiving the user input directed at the digital property listing, determining that the acquiring user profile does not have a current digital prequalification value range that includes a listing value of the digital property listing;
in response to determining that the acquiring user profile does not have a current digital prequalification value range that includes the listing value of the digital property listing, performing the following:
blocking the acquiring user profile from messaging a listing user profile for the digital property listing through a messaging user interface control in the digital property listing, the listing user profile is a listing agent user profile, with data in the computer subsystem indicating that the listing agent user profile corresponds to a property agent of an owner of a property represented by the digital property listing; and
providing in association with the digital property listing a user interface control that is selectable to forward the acquiring user profile to a prequalification service;
receiving from the prequalification service an indication of a new prequalification range for the acquiring user profile;
in response to verifying that the new prequalification range includes the listing value of the digital property listing, presenting the acquiring user profile with a message user interface control associated with the digital property listing, the message user interface control being selectable to initiate sending a digital message from the acquiring user profile to the listing user profile; and
sending a message from the acquiring user profile to the listing user profile after selection of the message user interface control.

12. The method of claim 11, wherein the method includes storing the new prequalification range in a computer subsystem, wherein the sending of the message from the acquiring user profile to the listing user profile after selection of the message user interface control is facilitated by the computer subsystem.

13. The method of claim 12, wherein the computer subsystem stores, maintains, and provides status data representing a status of a process for transferring a property represented by the digital property listing from a user of the listing user profile to a user of the acquiring user profile, and wherein the computer subsystem provides the listing user profile and the acquiring user profile with status updates from the status data.

14. The method of claim 11, wherein the facilitating further comprises sending multiple messages between the listing user profile and the acquiring user profile, the multiple messages comprising discussions of terms of an agreement for transferring a property represented by the digital property listing from a user of the listing user profile to a user of the acquiring user profile.

15. The method of claim 9, wherein the maintaining and providing status updates for the property transfer transactions comprises:
maintaining status updates for transferring a property represented by the digital property listing from a user of a listing user profile to a user of an acquiring user profile; and
providing the listing user profile and the acquiring user profile with the status updates for transferring the property represented by the digital property listing from the user of the listing user profile to the user of the acquiring user profile.

16. One or more computer-readable memory having computer-executable instructions embodied thereon that, when executed by at least one processor, cause at least one processor to perform acts comprising:
facilitating, via a computer subsystem, end-to-end property transfer transactions, the facilitating comprising:
managing listing user profiles, digital property listings of the listing user profiles, acquiring user profiles, and service provider user profiles, the listing user profiles comprising listing owner user profiles and listing agent user profiles;
at a single available computer subsystem, tracking and coordinating the property transfer transactions from listing of properties represented by the digital property listings to completion of transfers of the properties represented by the digital property listings from listing users represented by the listing user profiles to acquiring users represented by acquiring user profiles, the tracking and coordinating comprising:
receiving user input from an acquiring user profile selecting a digital property listing;
in response to receiving the user input directed at the digital property listing, determining that the acquiring user profile does not have a current digital prequalification value range that includes a listing value of the digital property listing;
in response to determining that the acquiring user profile does not have a current digital prequalification value range that includes the listing value of the digital property listing, performing the following:
blocking the acquiring user profile from messaging a listing user profile of the digital property listing through a messaging user interface control in the digital property listing; and
providing in association with the digital property listing a user interface control that is selectable to forward the acquiring user profile to a prequalification service;
receiving from the prequalification service an indication of a new prequalification range for the acquiring user profile;
verifying that the new prequalification range includes the listing value of the digital property listing;
in response to verifying that the new prequalification range includes the listing value of the digital property listing, providing the acquiring user profile with a message user interface control associated with the digital property listing, the message user interface control being selectable to initiate sending a digital message from the acquiring user profile to the listing user profile; and
sending a message from the acquiring user profile to the listing user profile after selection of the message user interface control.

17. The one or more computer-readable memory of claim 16, wherein the facilitating further comprises sending the digital property listings to one or more third-party property listing services via at least one listing publisher user profile.

18. The one or more computer-readable memory of claim 16, wherein the acts comprise indicating that the listing owner user profiles correspond to owners of properties represented by the digital property listings and indicating that the listing agent user profiles correspond to agents of owners of properties represented by the digital property listings.

19. The one or more computer-readable memory of claim 16, wherein the listing user profile is a listing agent user profile corresponding to an agent of an owner of the digital property listing.

20. The one or more computer-readable memory of claim 19, wherein the acts further comprise sending the message to a listing owner user profile corresponding to the owner of the digital property listing.
